(19) United States
(12) Patent Application Publication
(10) Pub. No.: US 2009/0145297 A1
(43) Pub. Date: Jun. 11, 2009

(54) CO2 ABSORPTION BY SOLID MATERIALS

(75) Inventors: Alan William Ferguson, Knoxville, TN (US); Robert Gudmundsen Hilton, Knoxville, TN (US)

Correspondence Address: ALSTOM POWER INC.;INTELLECTUAL PROPERTY LAW DEPT., P.O. BOX 500, WINDSOR, CT, 06095, US

(73) Assignee: ALSTOM Technology Ltd, Baden (CH)

(21) Appl. No.: 12/272,983

(22) Filed: Nov. 18, 2008

Related U.S. Application Data
(60) Provisional application No. 61/012,799, filed on Dec. 11, 2007.

(51) Int. Cl. B01D 53/62; B01D 53/14

(52) U.S. Cl. 95/90; 95/148; 96/108; 96/152; 96/154

(57) ABSTRACT

A system and method for capturing carbon dioxide (CO2) from a process gas stream is provided. An absorbent coated on a substrate (300) is subjected to a gas stream containing carbon dioxide (CO2) to remove at least a portion of the CO2 contained in the gas stream.

### CROSS REFERENCE TO RELATED APPLICATION(S)

This application claims priority to copending U.S. provisional application entitled, “CO₂ Absorption by Solid Materials”, having U.S. Ser. No. 61/012,799 filed on Dec. 11, 2007, the disclosure of which is entirely incorporated herein by reference.

### FIELD OF THE INVENTION

The proposed invention relates to a system and method for removing carbon dioxide (CO2) from a process gas stream containing carbon dioxide and sulphur dioxide. More particularly, the proposed invention is directed to a system and method for removing CO2 gas from a flue gas stream by contacting a flue gas stream to a CO2 absorbent that is disposed upon a solid material.

### SUMMARY OF THE INVENTION

Embodiments of the present invention provide a system and method for capturing carbon dioxide (CO2) from a process gas stream. Briefly described, in architecture, one embodiment of the system, among others, can be implemented so as to include an absorber vessel configured to receive a flue gas stream via a flue gas inlet.

Embodiments of the present invention can also be viewed as providing a method for removing CO2 from a flue gas stream. In this regard, one embodiment of such a method, among others, can be broadly summarized by the following steps: exposing a flue gas to an absorbent; and exposing the absorbent to a regeneration gas stream.

Other systems, methods, features, and advantages of the present invention will be or become apparent to those with ordinary skill in the art upon examination of the following drawings and detailed description. It is intended that all such additional systems, methods, features, and advantages be included within this description, be within the scope of the present invention, and be protected by the accompanying claims.

### BACKGROUND

In the combustion of a fuel, such as coal, oil, natural gas, peat, waste, etc., in a combustion plant, such as those associated with boiler systems for providing steam to a power plant, a hot process gas (or flue gas) is generated. Such a flue gas will often contain, among other things, carbon dioxide (CO2) The negative environmental effects of releasing carbon dioxide to the atmosphere have been widely recognised, and have resulted in the development of processes adapted for removing carbon dioxide from the hot process gas generated in the combustion of the above mentioned fuels. Systems and methods have been proposed for removing CO2 from a gas stream. These systems and methods include CO2 capture systems in which a flue gas is contacted with an aqueous absorbent solution such as, for example, a chilled ammonia based ionic solution such as that described and claimed in pending patent application PCT/US2005/012794 (International Publication Number: WO 2006/022885/Inventor: Eli Gal)), filed on 12 Apr. 2005 and titled Ultra Cleaning of Combustion Gas Including the Removal of CO².

FIG. 1A is a diagram generally depicting a flue gas processing system 15 for use in removing various pollutants from a flue gas stream FG emitted by the combustion chamber of a boiler system 26 used in a steam generator system of, for example, a power generation plant. This system is an aqueous absorbent solution (ionic solution) based CO2 capture system. It includes a CO2 removal system 70 that is configured to remove CO2 from the flue gas stream FG before emitting the cleaned flue gas stream to an exhaust stack 90 (or alternatively additional processing). It is also configured to output CO2 removed form the flue gas stream FG. Details of CO2 Removal system 70 are generally depicted in FIG. 1B.

With reference to FIG. 1B, CO2 removal System 70 includes a capture system 72 for capturing/removing CO2 from a flue gas stream FG and a regeneration system 74 for regenerating ionic solution used to remove CO2 from the flue gas stream FG. Details of capture system 72 are generally depicted in FIG. 1C.

With reference to FIG. 1C a capture system 72 of a CO2 capture system 70 (FIG. 1A) is generally depicted. In this system, the capture system 72 is a chilled ammonia based CO2 capture system. In a chilled ammonia based system/method for CO2 removal, an absorber vessel is provided in which an absorbent ionic solution (ionic solution) is contacted with a flue gas stream (FG) containing CO2. The ionic solution is typically aqueous and may be composed of, for example, water and ammonium ions, bicarbonate ions, carbonate ions, and/or carbamate ions. An example of a known CAP CO2 removal system is generally depicted in the diagram of FIG. 1C.

With reference to FIG. 1C, an absorber vessel 170 is configured to receive a flue gas stream (FG) originating from, for example, the combustion chamber of a fossil fuel fired boiler 26 (see FIG. 1A). It is also configured to receive a lean ionic solution supply from regeneration system 74 (see FIG. 1B). The lean ionic solution is introduced into the vessel 170 via a liquid distribution system 122 while the flue gas stream FG is also received by the absorber vessel 170 via flue gas inlet 76.

The ionic solution is put into contact with the flue gas stream via a gas-liquid contacting device (hereinafter, mass transfer device, MTD) 111 used for mass transfer and located in the absorber vessel 170 and within the path that the flue gas stream travels from its entrance via inlet 76 to the vessel exit 77. The gas-liquid contacting device 111 may be, for example, one or more commonly known structured or random packing materials, or a combination thereof.

Ionic solution sprayed from the spray head system 121 and/or 122 falls downward and onto/into the mass transfer device 111. The ionic solution cascades through the mass transfer device 111 and comes in contact with the flue gas stream FG that is rising upward (opposite the direction of the ionic solution) and through the mass transfer device 111.

Once contacted with the flue gas stream, the ionic solution acts to absorb CO2 from the flue gas stream, thus making the ionic solution “rich” with CO2 (rich solution). The rich ionic solution continues to flow downward through the mass transfer device and is then collected in the bottom 78 of the absorber vessel 170. The rich ionic solution is then regenerated via regenerator system 74 (see FIG. 1B) to release the CO2 absorbed by the ionic solution from the flue gas stream. The CO2 released from the ionic solution may then be output to storage or other predetermined uses/purposes. Once the CO2 is released from the ionic solution, the ionic solution is said to be “lean”. The lean ionic solution is then again ready to absorb CO2 from a flue gas stream and may be directed back to the liquid distribution system 122 whereby it is again introduced into the absorber vessel 170.

After the ionic solution is sprayed into the absorber vessel 170 via spray head system 122, it cascades downward onto and through the mass transfer device 111 where it is contacted with the flue gas stream FG. Upon contact with the flue gas stream the ionic solution reacts with CO2 that may be contained in the flue gas stream. This reaction is exothermic and as such results in the generation of heat in the absorber vessel 170. This heat can cause some of the ammonia contained in the ionic solution to change into a gas. The gaseous ammonia then, instead of migrating downward along with the liquid ionic solution, migrates upward through the absorber vessel 170, along with and as a part of the flue gas stream and, ultimately, escaping via the exit 77 of the absorber vessel 170.

These known CO2 capture systems require substantial equipment, such as pumps and storage tanks, to transport, cool/heat, circulate/recirculate and store ionic solution. FIG. 1D illustrates further details of an implementation of a known CO2 removal system 70. From FIG. 1D it can be seen that the aqueous absorbent based CO2 capture system 70 includes several pumps/pump systems (190, 192, 194) that circulate aqueous absorbent solution between various tanks and absorber vessels/absorber vessel systems (170, 180 and 182). It also includes one or more heat exchangers/heat exchange systems (150, 151, 152 and 153) that control the temperature of the aqueous absorbent solution. The capture system 70 also includes conduit/pipes to connect the various vessels, pumps and heat exchanger(s) together and allow for aqueous absorbent solution to flow between vessels. These pumps, vessels, heat exchangers and conduit devices/systems are costly to design and implement. Further they provide for a system of significant complexity to design, implement and operate. Costs savings and simplification may be realized by reducing the need for, for example, pumping equipment, storage/absorber vessels and heat exchangers at the site of the CO2 capture system. Thus, a heretofore unaddressed need exists in the industry to address the aforementioned deficiencies and inadequacies.

Further, features of the present invention will be apparent from the description and the claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. The invention will now be described in more detail with reference to the appended drawings in which:

FIG. 1A is a diagram generally depicting a typical flue gas processing system 15 that includes a CO2 removal system 70.

FIG. 1B is a diagram generally depicting further details of a typical CO2 removal system 70 that includes a capture system 72 and a regeneration system 74.

FIG. 1C is a diagram generally depicting details of a capture system 72.

FIG. 1D is a diagram generally depicting further details of a CO2 removal system 70.

FIG. 2A is a diagram generally depicting an embodiment of a CO2 removal system 70 that includes an ACS absorber system 250.

FIG. 2B is a diagram generally depicting further details of an ACS absorber system 250.

FIG. 2C is a diagram generally depicting the operation of the ACS absorber system 250 during an absorbent regeneration stage.

FIG. 3 is a diagram generally depicting the a relation of ACS 300 to the ACS absorber vessel 275.

FIG. 4 is a diagram generally depicting the contacting of flue gas with the ACS 300 during the absorption/capture stage of operation.

FIG. 5 is a diagram generally depicting the contacting of regeneration gas with the ACS 300 during the regeneration stage of operation.

FIG. 6 is a flowchart that is generally descriptive of one embodiment of a method for capturing CO2 from a flue gas.

FIG. 7 is a diagram generally depicting an embodiment of a CO2 removal system 70 in which multiple ACS Absorber Systems 275 are nested together to treat the flue gas stream form a common source.

FIG. 8A and FIG. 8B are diagrams generally depicting a further embodiment of an ACS absorber system 250 according to the present invention

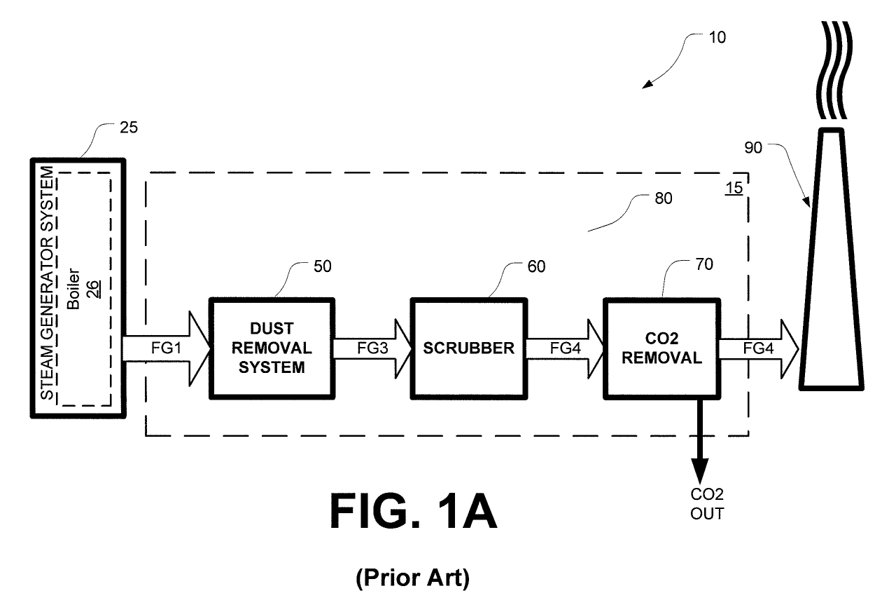

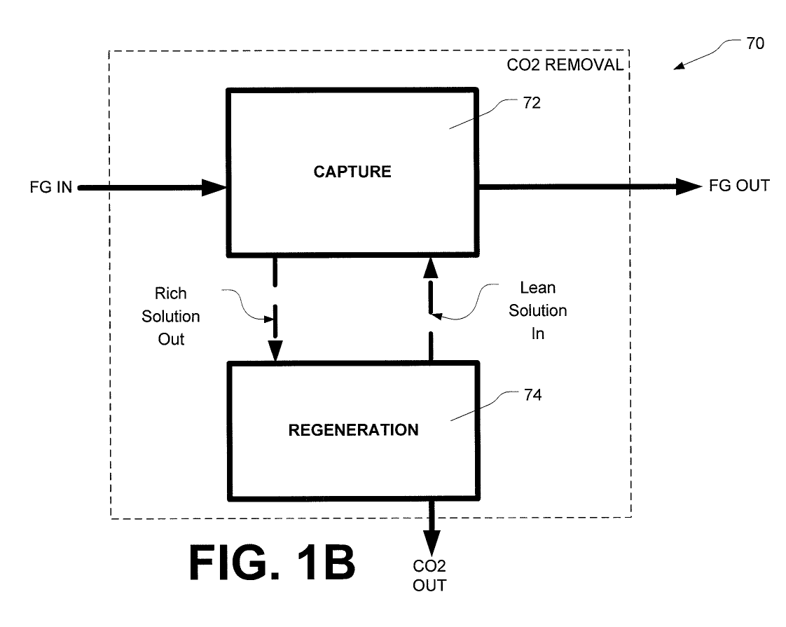

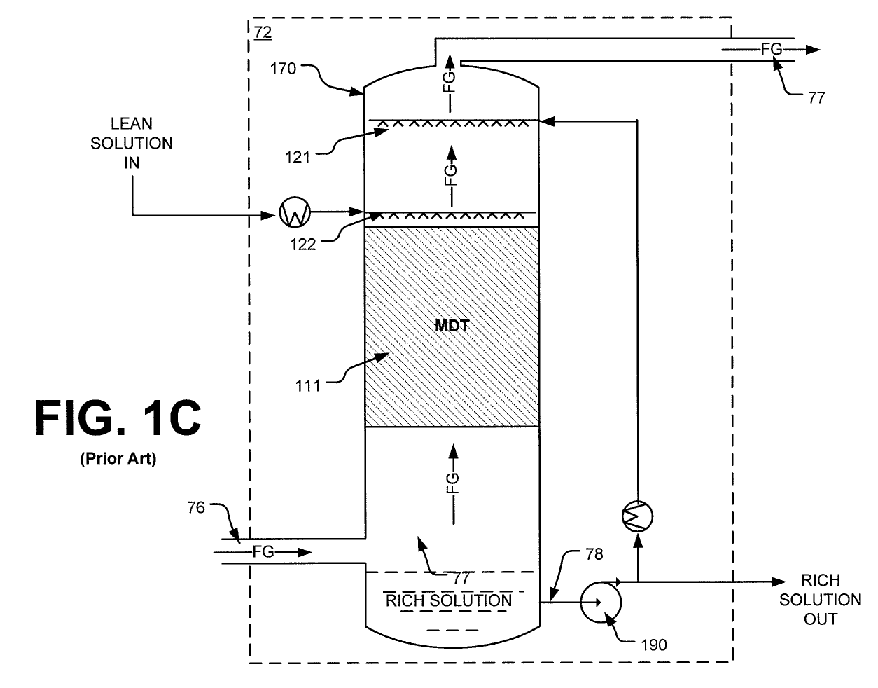

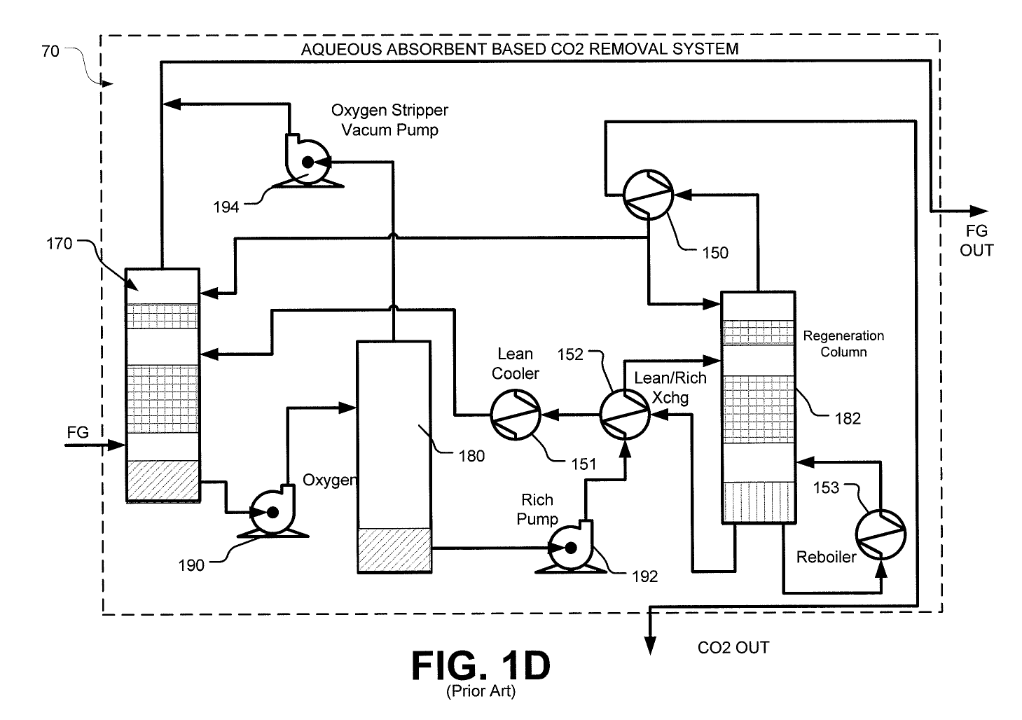

### DISCUSSION

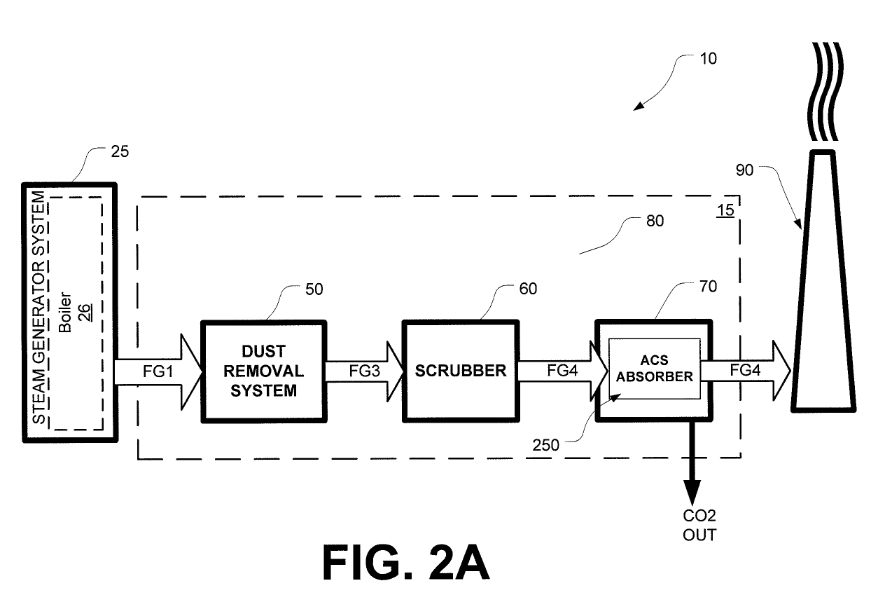

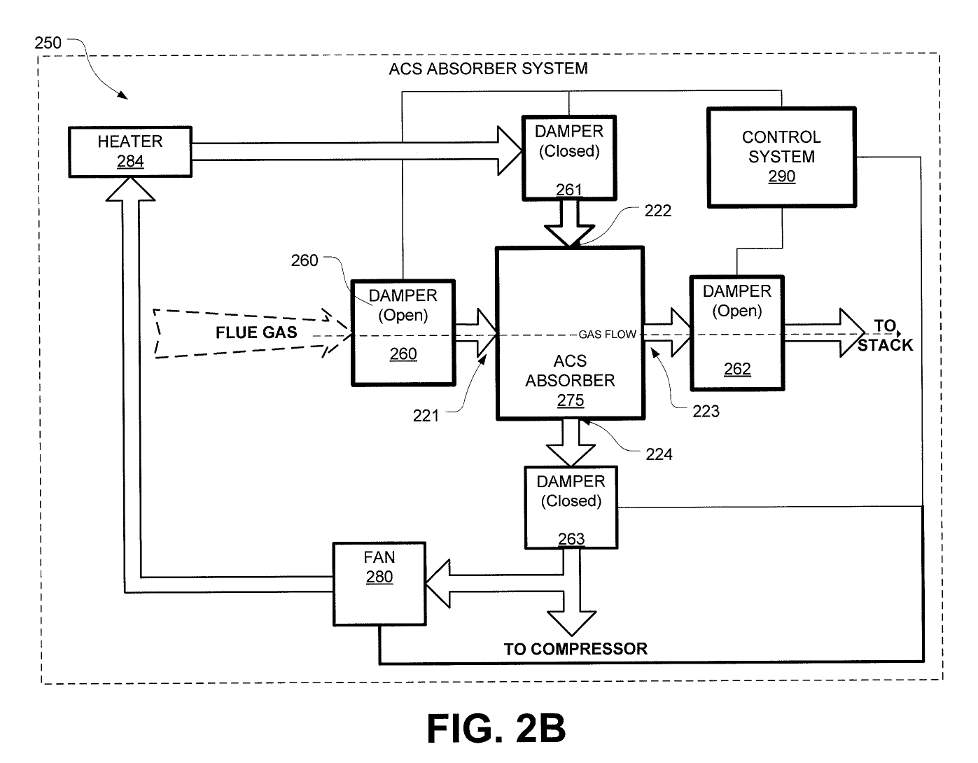

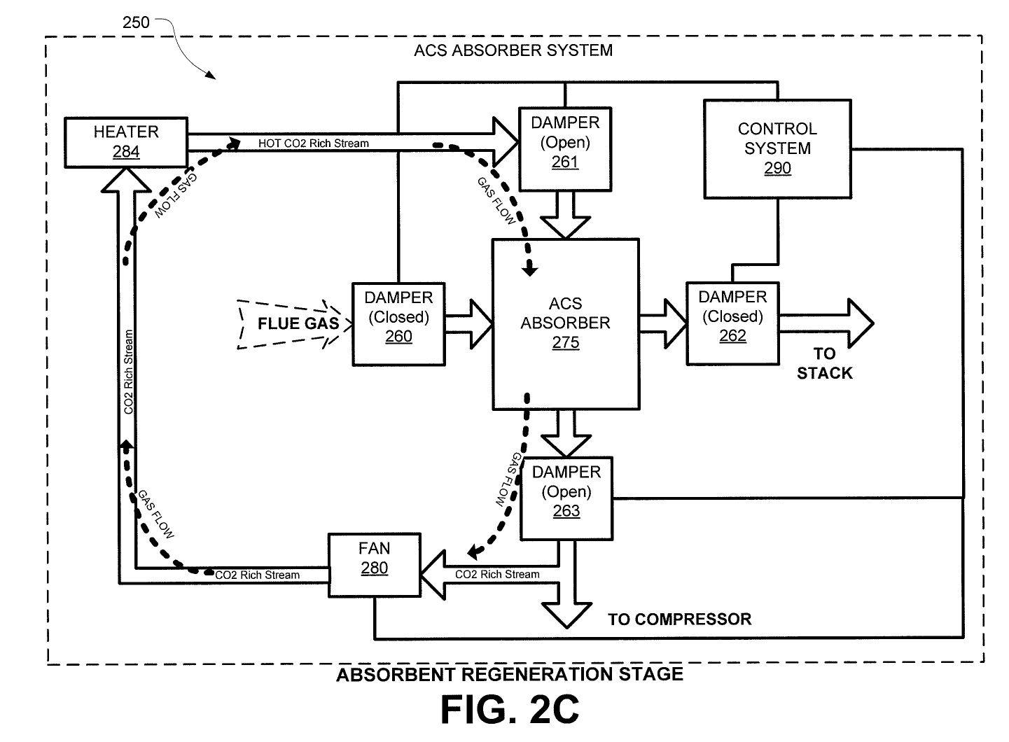

The proposed invention is directed to capturing CO2 gas from a flue gas stream by subjecting the flue gas stream to an absorbent that is coated on to a solid material or substrate, generally referred to herein as an absorbent coated substrate (ACS) 300. FIG. 2A-FIG. 6 are diagrams generally depicting aspects of a CO2 removal system 70 in which an ACS capture system 250 is provided.

FIG. 2A is a diagram showing an ACS absorber system 250 configured to receive a flue gas stream (FG) from a power generation system 25. The ACS Absorber system 250 is configured to remove CO2 that may exist in the FG and output the captured CO2 for, for example, compression, storage or other processing, while outputting the processed flue gas FG to an exhaust stack 90.

FIG. 2B and FIG. 2C are diagrams that provide further details of an embodiment of an ACS absorber system 250. In this embodiment, the ACS absorber system includes an ACS absorber vessel 275. The ACS absorber vessel 275 includes a flue gas input 221 for receiving flue gas from, for example, a power generation system 25 (not shown), and an exhaust outlet 223 that allows clean exhaust to be provided to, for example, an exhaust stack or further flue gas processing/treatment systems.

The flue gas input 221 and the exhaust outlet 223 are each provided, respectively, with a damper (260 & 262, respectively) that is controlled to be either “open” or “closed”, depending up the processing stage (“absorption stage” or “regeneration stage”) that the ACS absorber system 250 is engaged in.

The ACS absorber 275 is further provided with a regeneration gas inlet 222 and a CO2 outlet 224. The regeneration gas input and the CO2 outlet are each provided, respectively, with a damper (261 & 263, respectively) that is controlled to be either “open” or “closed”, depending up the processing stage (“absorption stage” or “regeneration stage”) that the ACS absorber system 250 is engaged in.

In a preferred embodiment the ACS 300 includes an absorbent that is coated (or otherwise applied) onto a substrate. The absorbent may be, for example, an amine or amine compound. Some examples, of amines and/or amine compounds that may be utilized as an absorbent, include, but are not limited to aqueous monoethanolamine (MEA), diglycolamine (DGA), diethanolamine (DEA), diisopropanolamine (DIPA) and/or methyldiethanolamine (MDEA), hydrogen sulfide (H2S) tetraethylenepentamine (TEPA), an acrylonitrile-modified tetraethylenepentamine (TEPAN), triethylenetetramine (TETA), and/or an acrylonitrile-modified ethyleneamine (ME-100), or other chemical. In a preferred embodiment, the absorbent is an acrylonitrile-modified tetraethylenepentamine (TEPAN).

The substrate may be composed of, for example, polymethyl methacrylate (PMMA) spheres such as those commonly available from suppliers such as, for example Dow Chemicals, Inc., Huntsman, BASF, and others. The substrate may also be composed of high surface area structure or material.

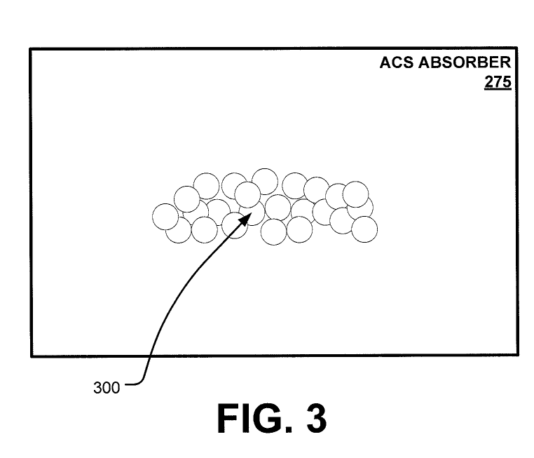

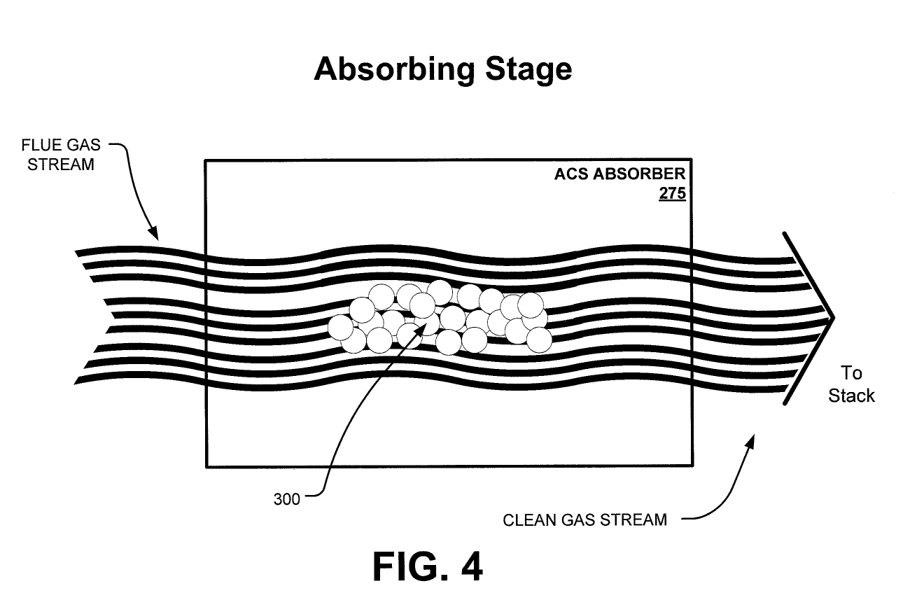

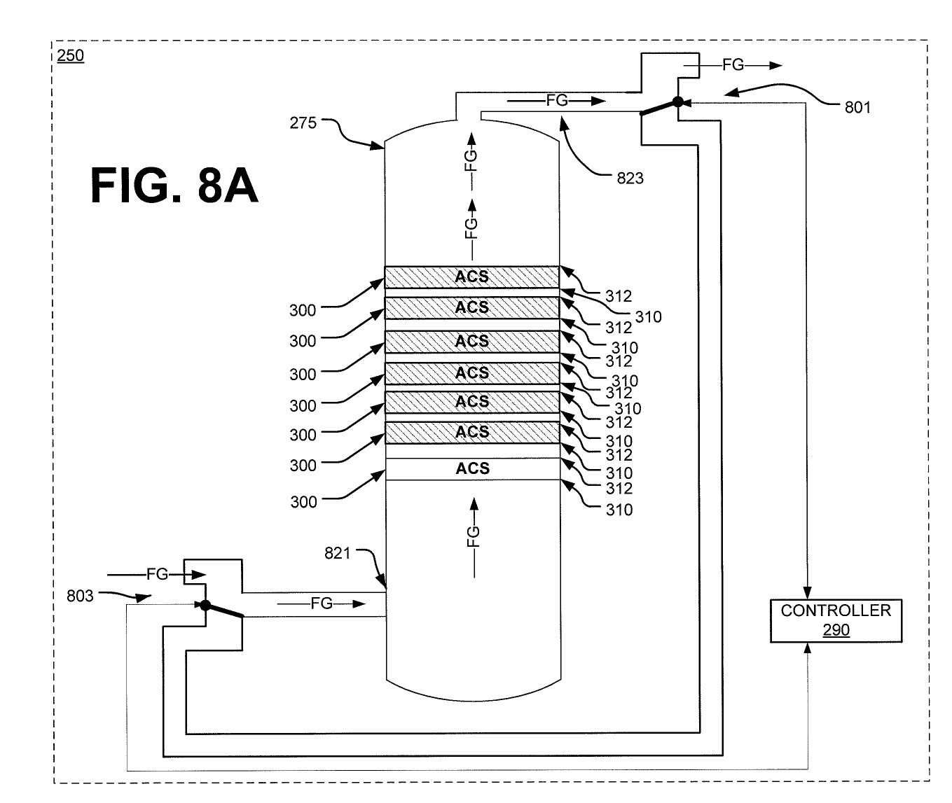

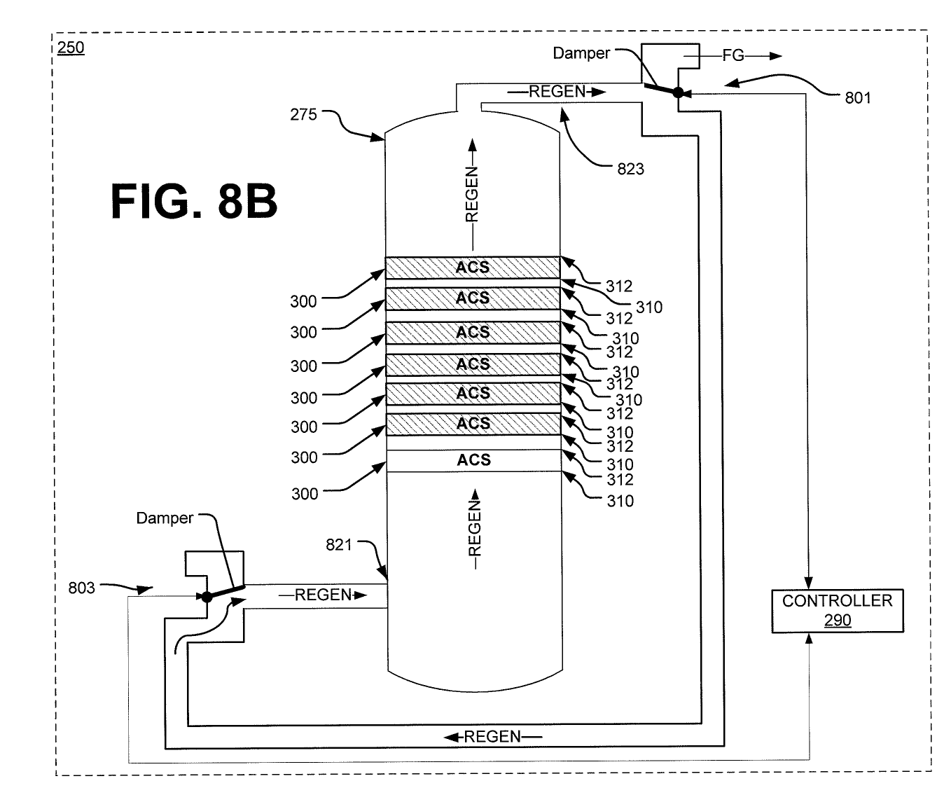

The ACS 300 is placed into an ACS absorber vessel 275 as generally depicted in FIG. 3, FIG. 8A and FIG. 8B. With reference to FIG. 3, the ACS is placed into the ACS absorber vessel 275 as generally depicted in FIG. 3. It is situated in the ACS absorber vessel 275 so that it can be exposed to a flue gas stream (FG) that may be introduced to the ACS absorber 275 via the flue gas inlet 221 (See FIG. 2B and FIG. 4). The ACS 300 is generally exposed to a flue gas stream only during the “absorption stage”. During the absorption stage, dampers 260 and 262 are controlled to allow flue gas to enter and exit the ACS absorber vessel 275, respectively, while dampers 261 and 263 are controlled to preclude any gas flow to/from the ACS absorber 275 thru the regeneration gas input and/or the CO2 output. As the flue gas is exposed to the ACS, CO2 within the flue gas is absorbed by the absorbent of the ACS leaving the flue gas to pass through the ACS absorber 275 and out the exhaust outlet to the stack with a lower level of CO2 present (see FIG. 4).

After a period of time, the absorbent of the ACS 300 will become saturated with CO2 that has been captured from a flue gas stream that contains CO2. Once the absorbent becomes saturated, it's ability to capture further CO2 from the flue gas stream is greatly reduced, if not completely lost. At this point, the absorbent of the ACS 300 can be refreshed or “regenerated” to make it capable of further CO2 capture.

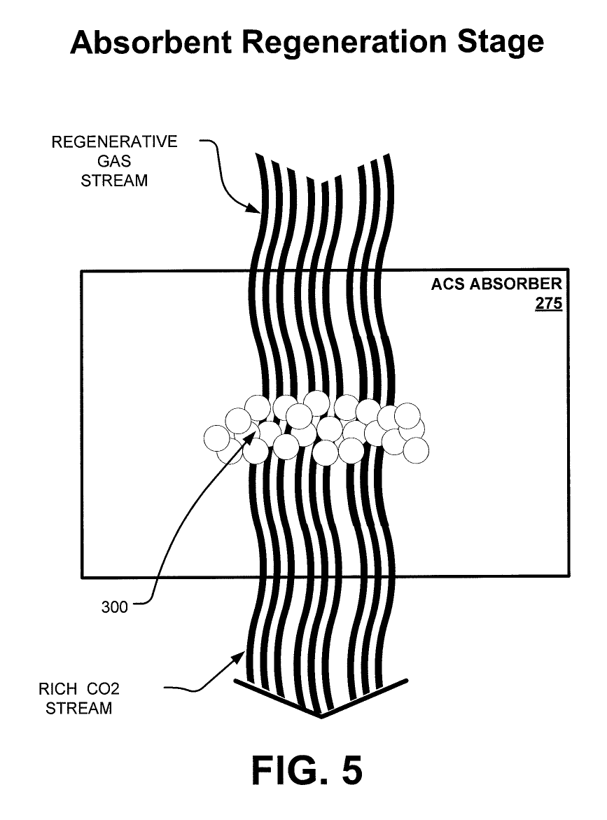

In a preferred embodiment, the absorbent is refreshed during the regeneration stage of system operation. During the “regeneration stage” the ACS 300 in the ACS absorber vessel 275 is exposed to regeneration gas received into the ACS absorber via the hot regeneration gas input. This is generally depicted in FIG. 2C and FIG. 5. The absorbent of the ACS 300 can be regenerated by subjecting it to a temperature that is high enough to cause the absorbent to release CO2 that has been captured by the absorbent.

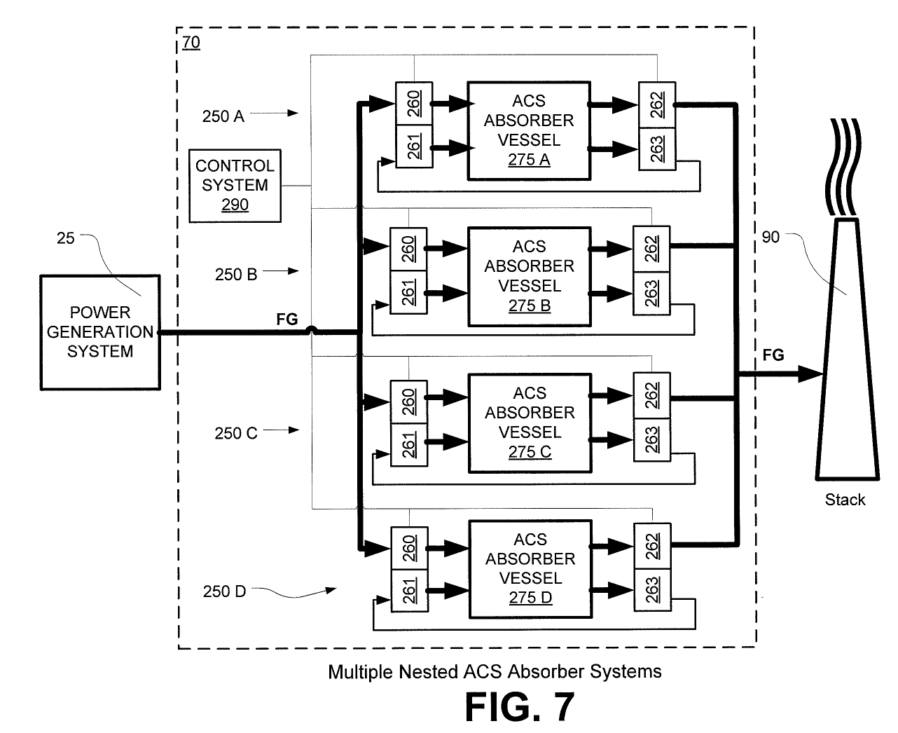

The ACS absorber vessel 275 is configured to receive regeneration gas that may be pulled from, for example, an additional adjacent/nested ACS absorber vessel (see FIG. 7) that is engaged in an absorbing stage of operation or via a separate input of regeneration gas (not shown). Regeneration gas may be composed of, for example, steam or CO2 that is at a temperature sufficient enough to cause the absorbent of the ACS to release absorbed CO2 therein (for example, between 35° C. and 140° C.). The flow of the regeneration gas through one embodiment of the system during the regeneration stage is generally depicted in FIG. 2C.

In a further embodiment, the ACS may be regenerated by evacuating CO2 from the ACS absorber 275 by reducing the pressure at the discharge side of the vessel 275 (via, for example, applying a vacuum to the vessel 275). The CO2 could then be collected for further processing/treatment. In this embodiment, the vessel 275 may be configured to allow a hot regeneration gas to be pulled into the vessel 275 as the pressure within the vessel 275 is reduced.

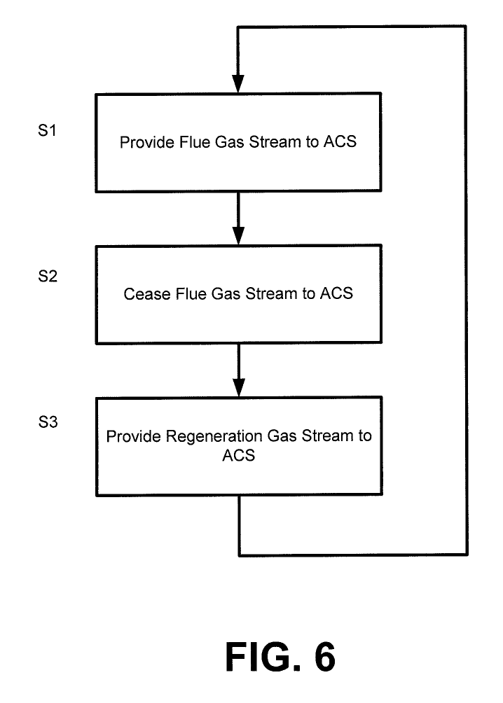

FIG. 6 is a flowchart that is generally descriptive of one embodiment of a method for capturing CO2 from a flue gas. In this embodiment, a flue gas stream is exposed to an ACS (S1) (this is typically carried out during a “absorprtion stage” of system operation). After being exposed to the flue gas stream (and CO2) the ACS is removed from contact with the flue gas stream, or otherwise isolated from the gas stream. This may be accomplished, for example, by moving the ACS away from the flue gas stream or redirecting the gas stream flow away from the ACS (S2). The ACS is then exposed to regeneration gas (this is typically carried out during a “regeneration stage” of system operation) (S3). The regeneration gas stream would preferably be a hot CO₂ rich stream or other gas stream, such as, for example, steam. CO₂ would be recovered from the solid substrate without changing the chemistry of the solid substrate, by increasing temp and/or decreasing pressure (or a combination thereof) thus allowing it to be reused again for further CO₂ absorption.

FIG. 7 is a diagram generally depicting an embodiment of the invention in which multiple ACS absorber systems are nested together to jointly receive flue gas from, for example, a power generation system and to jointly output exhaust to a stack (or series of stacks). The nested ACS absorbers may be configured to all simultaneously function in the absorption stage/regeneration stage of operation, or alternatively, they may be configured so that only some of the nested ACS absorbers carry out absorption stage operations while others of the nested ACS absorbers carry out regeneration stage operations.

In a preferred embodiment, the ACS absorber system will include a controller 290 for controlling, among other things, the dampers 260, 261, 262 and 263 and fans (280) in the system based upon predetermined criteria and input from one or more sensors (not shown) that provide input signals/data to indicate a then current status of various system features, attributes and equipment. The controller 290 is configured to issue commands or signal outputs to the dampers and/or fans, as may be appropriate, to control or otherwise adjust such things as gas flow, gas flow paths, temperature and atmosphere within the system.

FIG. 8A and FIG. 8B are diagrams generally depicting a further embodiment of an ACS system 250. In this embodiment an absorber vessel 275 is provided. The absorber vessel 275 includes an inlet 821 and an outlet 823. An inlet damper 803 is provided to control the flow of gas into the inlet 821. An outlet damper 801 is provided to control the flow of gas from the outlet 823. FIG. 8A shows the ACS system 250 as it operates in the capture mode/stage. In the capture mode, a flue gas stream FG is directed into the inlet 821 via the inlet damper 803. One or more beds of ACS 300 are disposed within the interior of the absorber vessel 275. These beds of ACS 300 may be supported in place by supports 310 and retainers 312. Supports 310 are configured to keep the beds of ACS 300 from falling from a desired position within the absorber vessel 275. The retainers 312 act to keep the beds of ACS 300 from moving upward away form the desired placement within the absorber vessel 275 due to, for example the force of the flow of flue gas or regeneration gas through the absorber vessel 275.

The flue gas stream migrates upward and through one of more beds of ACS 300 that are disposed within the interior of the absorber vessel 275. As the flue gas passes through the ACS 300, it is contacted with the ACS 300 whereby CO2 contained in the flue gas stream is captured by the absorbent of the ACS 300.

The use of a solid material, such as PMMA (Polymethyl methacrylate) spheres for CO₂ absorption and desorption will reduce, if not totally eliminate, the need to pump amine or other absorbent solutions from tanks into absorber vessels and then to regenerators to remove CO₂ from gas streams. This will eliminate the need for pumps, tanks and other expensive hardware, as well as costs associated with operating such.

The proposed invention can minimize the need for pumping of liquid streams for CO₂ removal and recovery from gas streams. Further, the proposed invention allows for costs savings due to the reduced need for pumping, heating and/or cooling equipment, as well as the costs associated with reduced energy usage/consumption.

Additionally, a reduction in thermal energy requirements for the regeneration step can be achieved. The low temperature requirements for each process (absorption and regenerations) allows the proposed invention to provide an economical alternative to conventional capture systems and processes. Similarly, since the system is dry it is not necessary to heat all the liquid phases to drive reactions thus resulting in significant energy savings.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed:

1. A system for removing CO2 from a flue gas wherein the system comprises an absorber vessel configured to receive a flue gas stream via a flue gas inlet.

2. The system of claim 1 wherein the absorber vessel is further configured to support an absorbent so that it can be exposed to the flue gas stream.

3. The system of claim 2 further comprising a damper for controlling the flow of a flue gas stream into the absorber.

4. The system of claim 2 wherein the absorbent is coated on a solid substrate.

5. The system of claim 4 wherein the absorbent comprises an amine.

6. The system of claim 4 wherein the absorbent comprises an amine compound.

7. The system of claim 5 wherein the solid substrate comprises Polymethyl methacrylate (PMMA) spheres.

8. The system of claim 5 wherein the solid substrate comprises a high surface area material.

9. A method of removing CO2 from a flue gas comprises the steps of:
exposing a flue gas to an absorbent; and
exposing the absorbent to a regeneration gas stream.

10. The method of claim 9 wherein the flue gas is exposed to an absorbent that is coated on a solid substrate.

11. The method of claim 9 wherein the absorbent comprises an amine.

12. The method of claim 8 wherein the solid substrate comprises polymethyl methacrylate (PMMA) spheres.

13. The method of claim 10 wherein the absorbent is exposed to a regeneration gas stream at a pressure level lower than the pressure level of the flue gas stream.

14. The method of claim 9 wherein the absorbent comprises an amine compound.

15. The method of claim 12 wherein the solid substrate comprises a high surface area material.

16. The method of claim 9 wherein the absorbent comprises an acrylonitrile-modified tetraethylenepentamine (TEPAN).

17. The method of claim 9 wherein the absorbent comprises tetraethylenepentamine (TEPA).

18. The method of claim 9 wherein the absorbent comprises an acrylonitrile-modified ethyleneamine (ME-100).

19. A system for removing CO2 from a flue gas wherein the system comprises:
an absorber vessel configured to receive a flue gas stream via a flue gas inlet and to support an absorbent so that it can be exposed to the flue gas stream;
a damper for controlling the flow of a flue gas stream into the absorber; and
wherein the absorbent is coated on a solid substrate.
